(19) United States
(12) Patent Application Publication
(10) Pub. No.: US 2004/0258930 A1
(43) Pub. Date: Dec. 23, 2004

(54) Grain-free polycrystalline silicon and a method for producing same

(75) Inventors: Masao Moriguchi, Vancouver, WA (US); Apostolos T. Voutsas, Vancouver, WA (US)

Correspondence Address: David C. Ripma, Patent Counsel, Sharp Laboratories of America, Inc., 5750 NW Pacific Rim Boulevard, Camas, WA, 98607, US

(73) Assignee: Sharp Laboratories of America Inc.

(21) Appl. No.: 10/602,266

(22) Filed: Jun. 23, 2003

(51) Int. Cl. B32B 9/04

(52) U.S. Cl. 428/446

(57) ABSTRACT

A polycrystalline silicon film with quasi-single crystal silicon in a selected region and a method for fabricating the polycrystalline silicon film are provided. The method comprises forming a film of amorphous silicon and using a 2N-shot process to form polycrystalline silicon in an area of the film. For 2N-shot process iterations, a laser beam is projected through aperture patterns to anneal the area. The laser forms two orthogonal groups of laser beamlets, causing two orthogonal groups of grain boundary to form in the area. The spacing within the groups is in a range of 0.1 microns (μm) to 100 μm. A directional solidification (DS) process projects a laser through an aperture pattern to sequentially anneal a portion of the area in a selected direction. The DS process smoothes grain boundary ridges and selectively removes grain boundaries.

### BACKGROUND OF THE INVENTION

1. Field of the Invention

This invention generally relates to liquid crystal display (LCD) and integrated circuit (IC) fabrication, and more particularly, to a silicon film and fabrication process for laser irradiating silicon film to produce polycrystalline silicon, in selected areas, free of grain boundaries.

2. Description of the Related Art

When forming thin film transistors (TFTs) for use in LCD or other microelectronic circuits, the location of transistors channel regions, the orientation of regular structured polycrystalline silicon (poly-Si) or single-grain-crystalline silicon, grain boundaries, and surface roughness are important issues. Poly-Si material can be used as the active layer of poly-Si TFTs in the fabrication of active-matrix (AM) backplanes. Such backplanes can be used in the fabrication of AM LCDs and can be also combined with other display technologies, such as organic light-emitting diodes (OLEDs).

Poly-Si material is typically formed by the crystallization of initially deposited amorphous silicon (a-Si) films. This process can be accomplished via solid-phase-crystallization (SPC), i.e., by annealing a-Si films in a furnace at appropriate temperature, for a sufficiently long time. Alternatively, laser annealing can also be used to achieve the phase transformation.

Conventionally, all crystallization techniques are applied to a given substrate in such a manner as to yield poly-Si film of a uniform quality throughout the substrate area. In other words, there is no spatial quality differentiation over the area of the substrate. For example, when a-Si film is annealed in a furnace or by rapid-thermal-annealing, the entire layer is exposed to the same temperature, resulting in the same quality of poly-Si material. In the case of conventional laser annealing, some differentiation is possible, but the price, in terms of loss of throughput, is very high for the modest performance gains. Hence, even for conventional laser annealing, quality differentiation is not practically feasible.

It would be advantageous if a laser annealing process with a high throughput could, in selected areas, produce grain boundary-free poly-Si and a smooth surface.

It would be advantageous if a laser annealing process with a high throughput could, in selected areas, increase grain boundary spacing while producing a smooth surface.

### SUMMARY OF THE INVENTION

The present invention describes a polycrystalline silicon film with quasi-single crystal silicon in a selected region. The present invention also describes a process that yields the above-mentioned polycrystalline silicon film with quasi-single crystal silicon. The present invention is accomplished using 2N-shot laser irradiation followed by laser beam directional solidification (DS) in the selected region. The present invention allows the formation of integrated circuit (IC) devices, such as thin film transistors (TFTs), having channel regions composed of quasi-single crystal silicon.

Accordingly, a method is provided for producing grain boundary-free polycrystalline silicon. The method includes forming a film of amorphous silicon and using a 2N-shot laser irradiation process to form polycrystalline silicon in an area of the film. The 2N-shot process sequences irradiation in odd and even iteration patterns. For the iterations, the method projects a laser beam through two aperture patterns to anneal the area. The method projects two orthogonal groups of laser beamlets per iteration. The beamlets cause two orthogonal groups of ridged, grain boundaries to form one the surface of the area. The spacing between boundaries in each group of boundaries is in a range of 0.1 microns (μm) to 100 μm. Then, a directional solidification (DS) process is used to anneal a selected portion of the area. The DS process projects a laser through an aperture pattern to sequentially anneal the selected portion in a selected direction. As part of the annealing, the DS process smoothes grain boundary ridges and selectively removes grain boundaries.

Additional details of the above-described method, and a polycrystalline silicon film with quasi-single crystal silicon in a selected region are presented in detail below.

### BRIEF DESCRIPTION OF THE DRAWINGS

FIG. 1 illustrates the growth of long polycrystalline silicon (poly-Si) grains by a Directional Solidification (DS) process.

FIG. 2 is a plan view of a conventional optical system mask.

FIG. 3 is a pictorial representation of a system using the above-mentioned optical projection and the step-and repeat-process.

FIG. 4 illustrates steps in a 2N-shot process, with N=2.

FIG. 5 is a pictorial representation showing possible configurations of a TFT on a poly-Si surface formed by the 2N-shot method.

FIG. 6 is a plan view of the present invention silicon film with quasi-single crystal silicon in a selected region.

FIG. 7 is a graph showing the relationship of sub-boundary spacing to n-type TFT mobility.

FIG. 8 is a plan view of a present invention TFT formed on the grid region shown in FIG. 6.

FIG. 9 is a partial cross-sectional view of the TFT shown in FIG. 8.

FIG. 10 is a plan view of a present invention TFT formed on the grid region shown in FIG. 6.

FIG. 11 is a partial cross-sectional view of the TFT shown in FIG. 10.

FIG. 12 illustrates the use of a directional solidification (DS) process following a 2N-shot process.

FIG. 13 shows angular distributions of the present invention silicon film and a quasi-single crystal.

FIG. 14 is a flowchart illustrating the present invention method for producing grain boundary-free polycrystalline silicon.

### DETAILED DESCRIPTION OF THE PREFERRED EMBODIMENTS

Laser-Induced Lateral Growth (LILaC) has significant flexibility and results in a wider variety of film microstructures. This technique relies on lateral growth of silicon grains using very narrow laser beams, which are generated by passing a laser beam through a beam-shaping mask and projecting the image of the mask to the film that is being annealed.

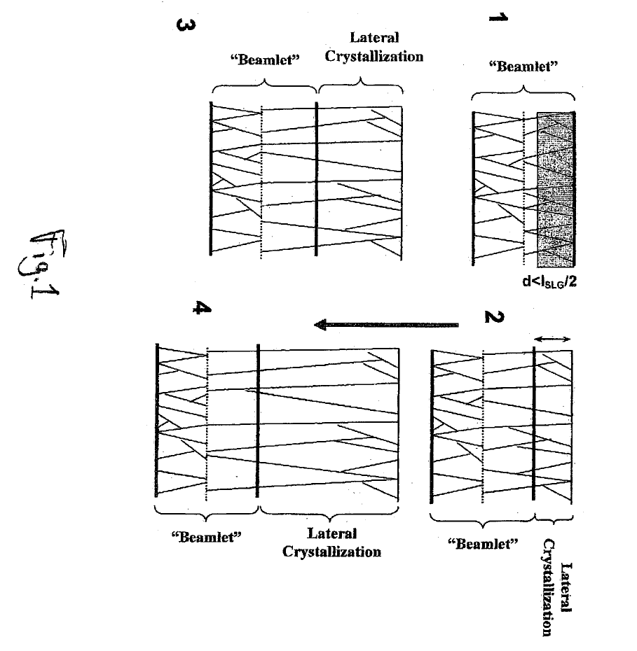

FIG. 1 illustrates the growth of long polycrystalline silicon (poly-Si) grains by a Directional Solidification (DS) process. One implementation of the LILac process is DS. DS uses a step-and-repeat approach as shown in FIG. 1. The laser beamlet width (indicated by the two parallel, heavy black lines) irradiates the film and, then steps a distance (d), smaller than half of the lateral growth length (L), i.e. d<L/2. Using this step-and-repeat process, it is possible to continually grow crystal grains from the point of the initial irradiation, to the point where the irradiation steps cease. L is dependent upon a combination of film thickness and substrate temperature. For example, a typical value of L, for a 50 nanometer (nm)-thick film at room temperature, is approximately 1.2 microns (μm). The lateral grain growth is due to the small advancing pitch of the beamlet. At each step, grains are allowed to grow laterally from the crystal seeds of the poly-Si material formed in the previous step.

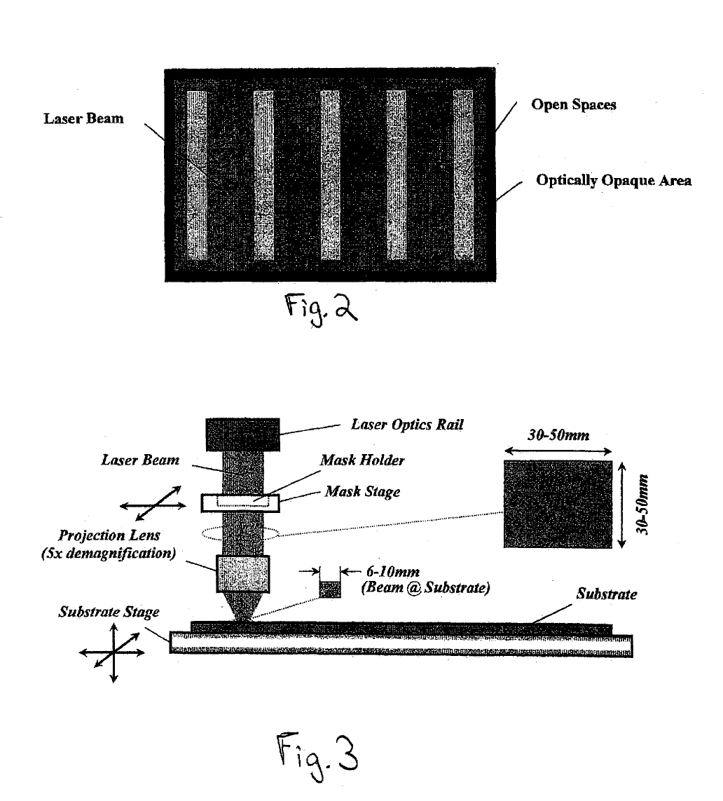

FIG. 2 is a plan view of a conventional optical system mask. The above-described process is equivalent to laterally “pulling” the crystals, as in zone-melting-crystallization (ZMR) method or other similar processes. As a result, the crystal tends to attain very high quality along the “pulling” direction, in other words, the direction of the advancing beamlets (shown by the arrow in FIG. 1). This process occurs in a parallel fashion (from each slit on the mask). Once an area is crystallized, the substrate moves to a new (unannealed) location and the process is repeated.

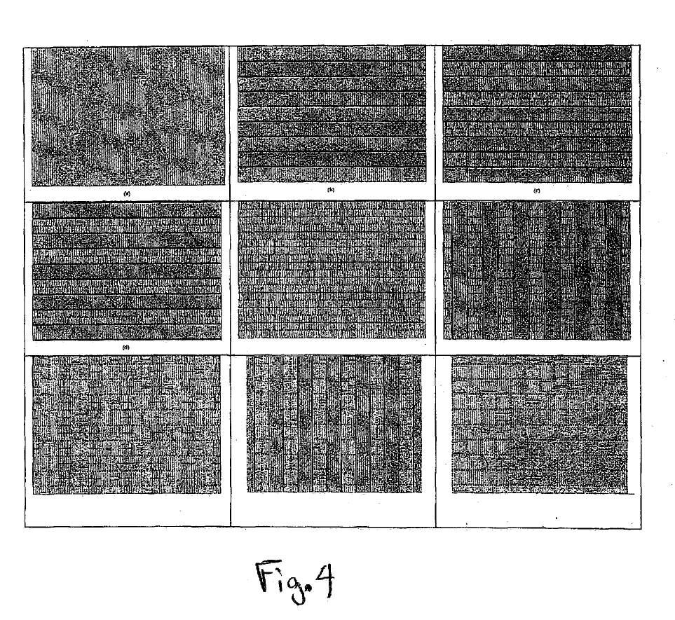

FIG. 3 is a pictorial representation of a system using the above-mentioned optical projection and the step-and repeat-process. At the first shot, the conjunction region of the lateral growth from the edge (center of the slit) has grain boundaries that deteriorate their electrical properties (mobility and threshold voltage [Vth]). The surface of this region is also undesirably rough due to ridges resulting from volume difference between liquid and solid. However, successive steps in the DS method smooth the roughness caused by preceding steps. Unfortunately, the throughput of the DS method is relatively low since the scanning pitch is typically limited to about 1 μm to prolong lateral growth. In addition, the mobility in the channel regions of thin film transistors (TFTs) using poly-Si produced by the DS method is limited by sub-boundary spacing, which is typically in the range of 0.1 μm to 0.5 μm.

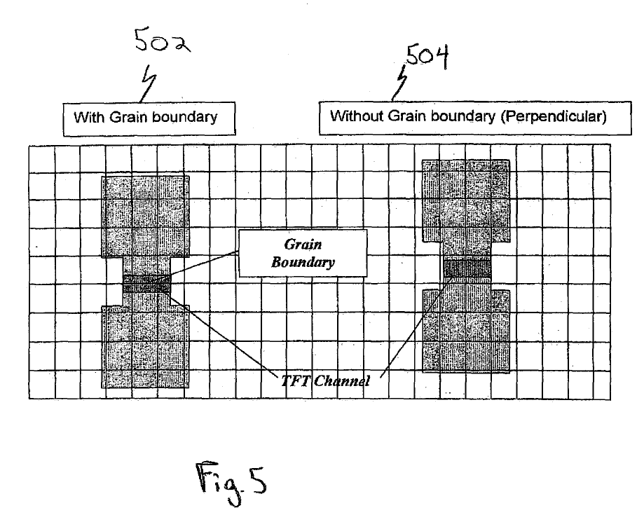

FIG. 4 illustrates steps in a 2N-shot process, with N=2. Recently, a new method, the 2N-shot method, was developed to increase process throughput. The 2N-shot method uses beam-shaping mask designs and/or scanning schemes for the substrate. In the 2N-shot method, an amorphous silicon (a-Si) film is exposed to a series of 2-shot laser irradiation steps with ‘N’ equal to the number of steps. For each step, the substrate (or beamlets) is rotated 90° with respect to the direction of lateral growth of the previous step. The 2N-shot method can provide very high throughput, on the order of less than 5 minutes for a glass substrate of 620×750 mm². The resulting poly-Si material has square grains within a square grid of grain boundaries. The 2N-shot method generally sweeps defects in the silicon material, however, within the square grains, a certain percentage of defects remain. In addition, the grid boundaries also cause some deterioration of the TFT characteristics. The grid boundaries are ridged, causing the poly-Si surface to be rough. This roughness requires the use of relatively thick gate insulating layers, for example, about 1000 angstroms (A), in TFT applications. Also, it is difficult to vary the location of the grain boundary grid. For each step in the 2N-shot process, grain boundary locations are determined by the fixed configuration of the apertures in the mask. That is, an individual aperture, corresponding to an individual grain boundary, cannot be moved without moving all the apertures (i.e., moving the mask). There may be some flexibility in the alignment of the mask for the first 2N-shot iteration in a sequence, however, there is likely a preferred alignment. To maximize use of a substrate, subsequent iterations will require aligning the mask with the boundaries from previous iterations. That is, there is little flexibility in mask alignments for subsequent iterations.

FIG. 5 is a pictorial representation showing possible configurations of a TFT on a poly-Si surface formed by the 2N-shot method. High-performance TFTs require high electron mobility through the transistor channel region. Grain boundaries perpendicular to a channel region cause deterioration of the final TFT characteristics. When the channel length of the TFT is less than, but comparable to the size of the square crystals, as shown in FIG. 5, there is limited flexibility in the placement of TFTs on a poly-Si substrate to avoid perpendicular grain boundaries. That is, to avoid perpendicular boundaries, the TFT channel must be nearly centered in a square crystal. When the channel length is greater than the size of the square crystal, the TFT cannot be placed so as to avoid perpendicular grain boundaries. In configuration 502, perpendicular and parallel grain boundaries are included in the TFT channel. In configuration 504, only parallel grain boundaries are included in the TFT channel. Obviously, increasing the distance between grain boundaries facilitates the placement of TFT channels so as to avoid grain boundaries, particularly grain boundaries perpendicular to the channel.

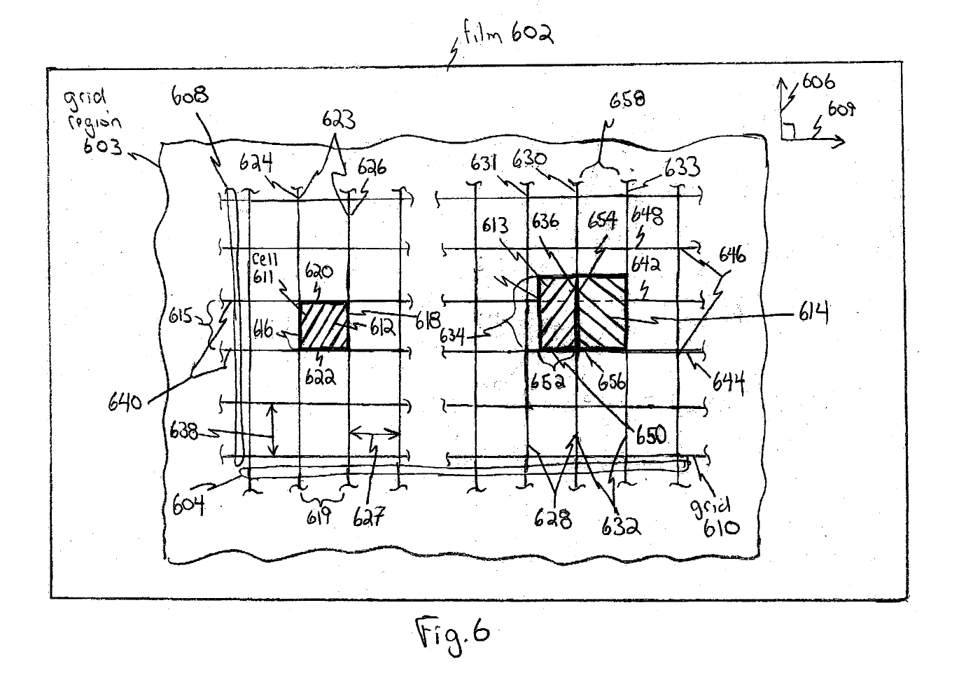

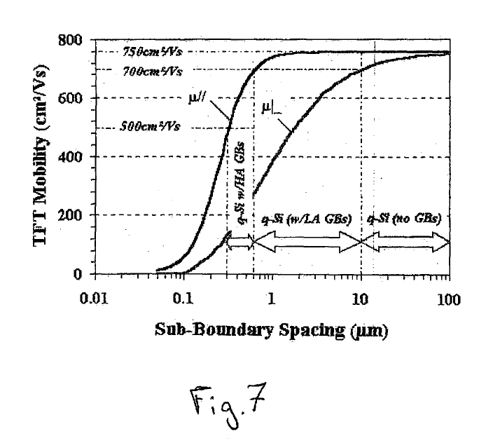

FIG. 6 is a plan view of the present invention silicon film with quasi-single crystal silicon in a selected region. An a-Si film 602 includes a grid region 603 of polycrystalline silicon. The region 603 has a plurality 604 of parallel grain boundaries (GBs) oriented in a first direction 606 and plurality 608 of parallel GBs oriented in a second direction 609. In general, consecutive first direction GBs 604 are equally spaced and consecutive second direction GBs 608 are equally spaced. However, other spacing configurations are possible. First direction GBs 604 and second direction GBs 608 form a grid 610 of GBs. The grid 610, in turn, forms cells, such as cell 611. First direction GBs 604 and second direction GBs 608 are formed by a series of 2N-shot laser irradiation sequences performed on the amorphous silicon film 602. Typically, the 2N-shot process results in the first direction GBs 604 and second direction GBs 608 being orthogonally oriented as shown in FIG. 6. The 2N-shot process is described in the Background Section. In FIG. 6, N is greater than or equal to 2. It should be understood that N also may be equal to 1, in which case, the film 602 has only one plurality of grain boundaries, for example, either 604 or 608. In general, the film 602 is rectangular, although it should be understood that other shapes are possible. It should be understood that the first direction GBs 604 and second direction GBs 608 are not limited to any particular number of GBs and the first direction GBs 604 and second direction GBs 608 may each contain a different number of GBs.

The grid region 603 includes a plurality of quasi-single crystals, for example, crystals 612, 613, and 614. A quasi-single crystal is a polycrystalline region bounded by, but free of, high angle grain boundaries. A quasi-single crystal may contain low angle grain boundaries. High angle grain boundaries are grain boundaries separating crystal domains with crystallographic orientations rotated by more than 15 degrees with respect to each other. Low angle grain boundaries are grain boundaries separating crystal domains with crystallographic orientations rotated by 15 degrees or less with respect to each other. In general, quasi-single crystals can be located anywhere within the grid region 603. It should be understood that the present invention is not limited to any particular number of quasi-single crystals or quasi-single crystal locations in grid region 603. The following description is for crystal 612, however, it should be understood that the description applies to crystals 613 and 614 also. The crystal 612 is formed by DS of the grid region 603 in the area occupied by crystal 612, that is, cell 611. As a result, the crystal 612 is generally rectangular in shape. In some aspects, the direction of the DS process is chosen to match the direction of the final iteration in the 2N-shot process.

The crystal 612 has a length 615 formed by sides 616 and 618 and a width 619 formed by sides 620 and 622. The length 615 is typically oriented to match the direction of the DS process. The sides forming the length of a crystal, for example, sides 616 and 618 for crystal 612 are located between a pair of consecutive GBs in plurality 604. For crystal 612, the pair 623 is made up of GBs 624 and 626. By located between, we mean that the sides can be co-located on one or both of the GBs, as explained below. That is, the width of a crystal is equal to or less than the distance 627 between GBs in plurality 604. The sides of a crystal forming the length can be co-located on the GBs in a pair of consecutive GBs, as shown for crystal 612. For example, sides 616 and 618 are located on GBs 624 and 626, respectively. It should be understood that other configurations are possible. For example, crystal 613 is located between pair 628 made up of GBs 630 and 631 and crystal 614 is located between pair 632 made up of GBs 630 and 633. However, for crystal 613, only one side forming the length 634 (side 636) is co-located on a GB (GB 630) from the pair 628. Another possible configuration (not shown) is for neither of the sides forming the length of a crystal to be co-located on the GBs between which they are located.

In general, the length 615 is independent of the distance 638 between GBs in plurality 608 because, as explained below, the DS process removes GBs perpendicular to the direction of the process. The length 615 is typically determined by specifications associated with applications (not shown) and process parameters. For example, if the crystal 612 is used for a channel region in a TFT, the length 615 is constrained by parameters such as the thickness of the film 602 and the energy densities associated with the 2N-shot and DS processes. In general, the sides of a crystal forming the width, for example sides 620 and 622 for crystal 612, are located between a pair of GBs in plurality 608, for example, pair 640 made up of GBs 642 and 644. By located between, we mean that the sides can be co-located on one or both of the GBs. For example, for crystal 612, sides 620 and 622 are located on GBs 642 and 644, respectively. It should be understood that other configurations are possible. For example, crystal 613 is located between pair 646 made up of GBs 644 and 648. However, only one side, side 650, forming the width 652 is co-located on a GB (GB 644) from the pair 646. Another possible configuration (not shown) is for neither of the sides forming the width of a crystal to be co-located on the GBs between which they are located.

The sides of a crystal forming the width can be located between a pair of consecutive GBs, for example, GBs 642 and 644 as shown for crystal 612, or between non-consecutive GBs, for example, GBs 644 and 648 as shown for crystals 613 and 614. It should be understood that a non-consecutive pair of GBs is not limited to a particular non-consecutive relationship. That is, the pair may be separated by more than one GB.

The DS process forms silicon quasi-single crystals, for example, crystals 612, 613, and 614. The DS process removes sub-boundaries within grid cells, for example, cell 611, and smoothes ridges formed by the first direction GBs 604 and second direction GBs 608. The DS process also removes grid GBs perpendicular to the direction of the process, for example, the portion of GB 642, marked with a dashed line, in crystals 613 and 614. The DS process does not remove GBs in the plurality of GBs parallel to the direction of the process.

In some cases, crystals are adjoined, that is, crystals share GBs. Typically, crystals share a GB parallel to sides forming the crystal length. For example sides 636 and 654 for crystals 613 and 614, respectively, are co-located on GB 630. Typically, the sides forming the widths of adjoining crystals are in alignment, for example, sides 650 and 656, forming the width 652 and a width 658 for crystals 613 and 614, respectively. It should be understood that more than two crystals can be adjoined and that other configurations are possible for adjoining crystals. Typically, adjoining crystals are formed by the same DS sequence, that is, the width covered by the DS process is equal to the combined widths of the adjoined crystals.

In general, the distances 627 and 638 are each in a range of 0.1 μm to 100 μm. Carrier mobility is related to the distances 627 and 638 and is discussed further below. The upper end of the range is dependent on the characteristics of the 2N-shot process forming grid region 603. In general, the greater the distance 627 or 638, the higher the energy density required in the 2N-shot process. In some aspects, distances 627 and 638 are in a range of 0.3 μm up to 0.6 μm. In some aspects, distances 627 and 638 are in a range of 0.6 μm to 10 μm. In some aspects, distances 627 and 638 are in a range of 10 μm to 100 μm. It should be understood that there is no requirement for the distances 627 and 638 to be in a same range. For example, distance 627 could be in the range of 0.3 μm to 0.6 μm and distance 638 could be in the range of 0.6 μm to 10 μm.

The distances 627 and 638 can be controlled, within ranges discussed further below, by selecting parameters in the 2N-shot process, specifically, the width of laser beamlets. The distances 627 and 638 are shown equal in FIG. 6. That is, the cell 611 is square. However, it should be understood that the distances 627 and 638 can be unequal (not shown). In that case, the grid 611 is rectangular. The choice between a square or rectangular cell can be made according to the desired specifications for the grid region 603 and crystals included in the region 603.

FIG. 7 is a graph showing the relationship of sub-boundary spacing to n-type TFT mobility. In FIG. 7, the horizontal axis shows sub-boundary spacing in μm, and the vertical axis shows n-type TFT mobility in square centimeters per volt-second (cm²/Vs). The scales of the axes are shown on FIG. 7. The two curves plotted in FIG. 7 show mobility as a function of sub-boundary spacing for a n-type TFT (not shown) having channels parallel (μ//) to the direction of crystalline lateral growth and for a n-type TFT (not shown) having channels perpendicular (μ|_) to the direction of lateral growth. For a TFT channel perpendicular to the direction of crystalline lateral growth in the silicon film, sub-boundaries oppose the free-flow of charge carriers through the channel and the carrier mobility in the channel is strongly dependent upon the spacing of the sub-boundaries. For a TFT channel parallel to the direction of lateral growth, the sub-boundaries are parallel to the direction of charge carrier flow. Hence, for the channel parallel to the grain boundaries, the carrier mobility is less dependent upon the spacing of the sub-boundaries, and, for a given sub-boundary spacing, the carrier mobility is greater than for a channel perpendicular to the grain boundaries. As the sub-boundary spacing increases, the energy barrier posed by the sub-boundaries decreases and, eventually, the high-angle sub-boundaries become low-angle sub-boundaries. At the limit of sub-boundary spacing shown in FIG. 7, the quasi-single crystal silicon is nearly of crystalline silicon quality.

The reduction of sub-boundary spacing in polycrystalline silicon produced by a single conventional LILaC process, such as 2N-shot or DS is limited. For example, DS polycrystalline silicon typically does not have sub-boundary spacing greater than 0.5 μm. 2N-shot poly-Si can have a relatively wide grid of GBs, however, high-angle GBs are present between the grid GBs, reducing overall sub-boundary spacing. Returning to FIG. 6, the quasi-single crystals 612, 613, and 614 are produced by a combination of 2N-shot and DS. As described for FIG. 6, the DS process removes high angle GBs perpendicular to the direction of the DS process and generally improves crystalline quality.

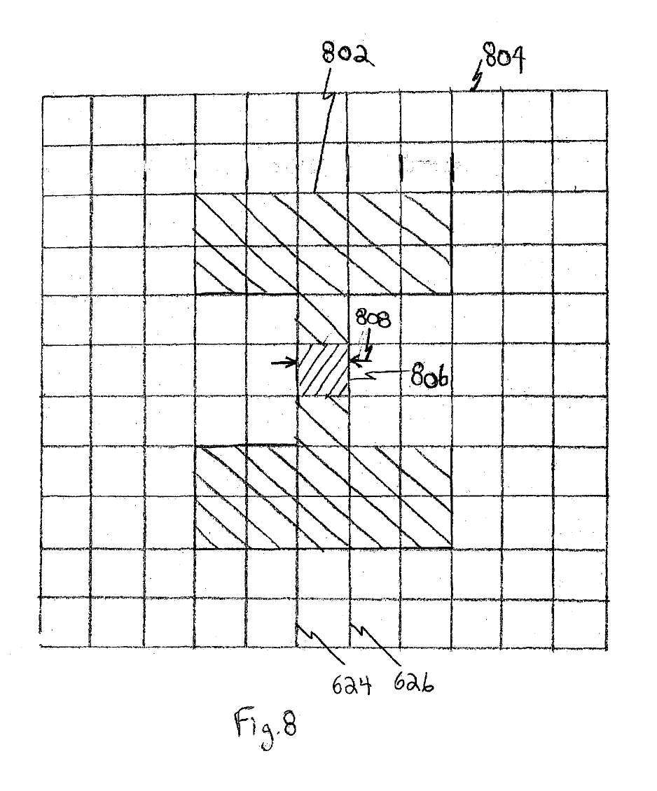

FIG. 8 is a plan view of a present invention TFT formed on the grid region 603 shown in FIG. 6. It should be understood that the TFT of FIG. 8 is offered only as one illustration of the invention. TFT 802 includes a portion of a poly-Si layer 804 formed from the grid region (reference designator 603 in FIG. 6). The layer 804 includes a channel region 806 formed from a quasi-single crystal (reference designator 612 in FIG. 6). The channel region 806 has a width 808 equal to the crystal width (reference designator 619 in FIG. 6), which, in the example under discussion, is the same as the distance (reference designator 627 in FIG. 6) between GBs in the first plurality of GBs (reference designator 604 in FIG. 6). It should be understood that in other configurations, the channel width 808 can be less than distance 627. Thus, the appropriate sub-boundary value in FIG. 7 for determining carrier mobility for TFT 802 is the channel width 808.

The DS process forming a quasi-single crystal, such as crystal 612, removes sub-boundaries between GBs in plurality 604 and between GBs in the second plurality (reference designator 608 in FIG. 6). Therefore, it should be understood that regardless of the orientation of the channel 806, the μ// curve in FIG. 7 is applicable. For example, the channel 806 could be rotated 90 degrees (not shown), thereby forming the width 808 with the crystal 612 length (reference designator 615 in FIG. 6). Then, for the example under discussion, the distance (reference designator 638 in FIG. 6) between GBs in plurality 608 is the appropriate sub-boundary value in FIG. 7 for determining carrier mobility for TFT 802. It should be understood that in this configuration, the channel width 808 can be less than distance 638. Thus, the μ// curve in FIG. 7 is applicable to the remainder of this discussion of preferred embodiments. The distances 627 and 638, and hence the channel width 808, are in a range of 0.1 μm to 100 μm. Thus, the entire range of carrier mobility values in FIG. 7 is applicable to TFT 802.

FIG. 7 can be used to determine carrier mobility numbers for quasi-single crystal silicon film, such as crystal 612. As described for FIG. 7, the appropriate sub-boundary value from FIG. 7 for determining carrier mobility for crystal 612 is either the distance 627 or the distance 638, both of which are in a range of 0.1 μm to 100 μm. In some aspects, the distances 627 and 638 are in a range of 0.3 μm to 0.6 μm. Then, referring to FIG. 7, for an n-type crystal 612, carrier mobility is greater than 500 cm²/Vs. For FIG. 7, the ratio of n/p mobility is constant and equal to the n/p mobility for single crystal silicon TFTs, which is approximately ⅓ to ½. Therefore, p-type TFT mobility values can be derived from FIG. 7. Thus, for a p-type crystal 612, carrier mobility is greater than 200 cm²/Vs. When we say that carrier mobility is greater than a specified value, we mean that the carrier mobility also can be equal to the specified value. The preceding usage of ‘greater than’ is applicable to the remainder of this discussion of preferred embodiments.

In some aspects, the distances 627 and 638 are in a range of 0.6 μm to 10 μm. Then, referring to FIG. 7, for an n-type crystal 612, carrier mobility is greater than 700 cm²/Vs. For a p-type crystal 612, carrier mobility is greater than 250 cm²/Vs.

In some aspects, the distances 627 and 638 are in a range of 10 μm to 100 μm. Then, referring to FIG. 7, for an n-type crystal 612, carrier mobility is approximately 750 cm²/Vs. For a p-type crystal 612, carrier mobility is greater than 250 cm²/Vs.

In like manner, FIG. 7 also can be applied to adjoining crystals, such as crystals 613 and 614 in FIG. 6. Crystal 613 has a width (reference designator 650 in FIG. 6) less than the distance 627 between GBs in plurality 604. Thus, in this aspect, the mobility associated with crystal 613 is dependent upon the width 650. That is, the width 650 is used as the applicable sub-boundary spacing value in FIG. 7. For crystal 614, which, like crystal 612, has a length bound by consecutive GBs in plurality 604, the above discussion regarding FIG. 7 and crystal 612 is applicable.

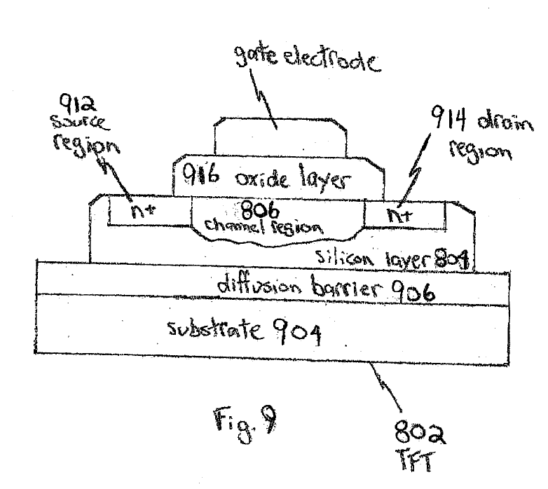

FIG. 9 is a partial cross-sectional view of the TFT 802 shown in FIG. 8. In the TFT 802, a transparent substrate 904 is overlain by a diffusion barrier 906. The poly-Si layer (reference designator 804 in FIG. 7) overlies the diffusion barrier 906. The silicon layer 804 includes a channel region (reference designator 806 in FIG. 8), a source region 912, and a drain region 914. An oxide gate insulator layer 916 overlies the silicon layer 804 and a gate electrode 918 overlies the oxide gate insulator layer 916. Because the surface (not shown) of the channel region 806 is smooth, the thickness of the portion of the gate insulator layer 916 overlying the channel region 806 can be relatively thin, in a range of 20 A to 500 A. Minimizing gate insulator layer thickness permits reductions in geometry for devices such as TFT 802.

As described in FIG. 8, the channel region 806 is a single quasi-single crystal (reference designator 612 in FIG. 6) and the channel width 808 is the applicable sub-boundary spacing value to determine TFT 802 mobility from FIG. 7. In some aspects, the channel width 808 is in a range of 0.3 μm to 0.6 μm. Then, referring to FIG. 7, for an n-type TFT 802, carrier mobility is greater than 500 cm²/Vs and Vₜₕ is less than and equal to +/−0.35V in a range of 0V to 1V. For a p-type TFT 802, carrier mobility is greater than 200 cm²/Vs and Vₜₕ is less than and equal to +/−0.35V in a range of −1V to 0V. When we say that a Vₜₕ is less than and equal to a specified value, we mean that the Vₜₕ can be equal to the specified value or can be less than the specified value. The preceding usage of ‘less than and equal to’ is applicable to the remainder of this discussion of preferred embodiments.

In some aspects, the channel width 808 is in a range of 0.6 μm to 10 μm. Then, referring to FIG. 7, for an n-type TFT 802, carrier mobility is greater than 700 cm²/Vs and Vₜₕ is less than and equal to +/−0.1V in a range of 0V to 0.8V. For a p-type TFT 802, carrier mobility is greater than 250 cm²/Vs and Vₜₕ is less than and equal to +/−0.1V in a range of −0.8V to 0V.

In some aspects, the channel width 808 is in a range of 10 μm to 100 μm. Then, referring to FIG. 7, for an n-type TFT 802, carrier mobility is approximately 750 cm²/Vs and Vₜₕ is less than and equal to +/−0.01V in a range of 0V to 0.1V. For a p-type TFT 802, carrier mobility is greater than 250 cm²/Vs and Vₜₕ is less than and equal to +/−0.01V in a range of −0.1V to 0V.

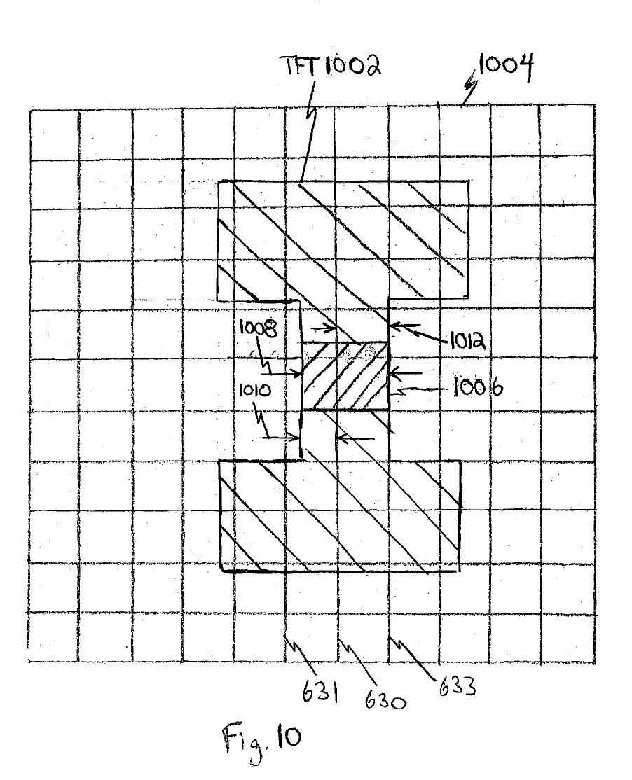

FIG. 10 is a plan view of a present invention TFT formed on the grid region 603 shown in FIG. 6. It should be understood that the TFT of FIG. 10 is offered only as one illustration of the invention. TFT 1002 includes a portion of a poly-Si layer 1004 formed from the grid region (reference designator 603 in FIG. 6). The layer 1004 includes a channel region 1006 formed from a group of adjoining quasi-single crystals (reference designators 613 and 614 in FIG. 6). The channel region 1006 has a composite width 1008. The composite width 1008 includes widths 1010 and 1012, corresponding to widths 652 and 658, respectively, in FIG. 6. By using a group of adjoining crystals, the width of the channel region can be extended, increasing the options for the TFT 1002 geometry. The discussion for FIG. 8 regarding the orientation of the channel 806 is applicable to the channel 1006.

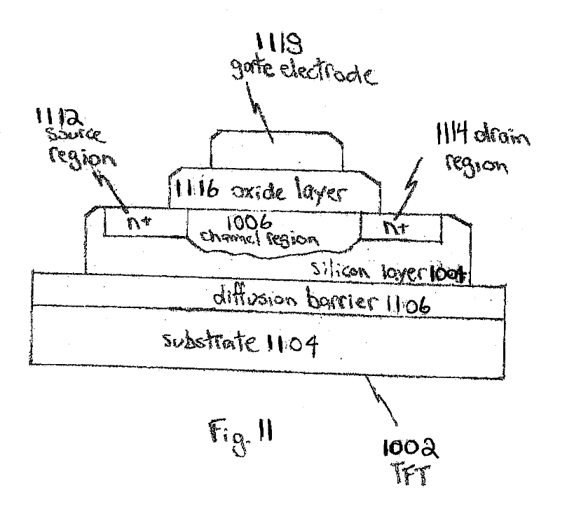

FIG. 11 is a partial cross-sectional view of the TFT shown in FIG. 10. In the TFT 1002, a transparent substrate 1104 is overlain by a diffusion barrier 1106. The polycrystalline silicon layer (reference designator 1004 in FIG. 10) overlies the diffusion barrier 1106. The silicon layer 1004 includes a channel region (reference designator 1006 in FIG. 10), a source region 1112, and a drain region 1114. An oxide gate insulator layer 1116 overlies the silicon layer 1004 and a gate electrode 1118 overlies the oxide gate insulator layer 1116. Because the surface (not shown) of the channel region 1006 is smooth, the thickness of the portion of the gate insulator layer 1116 overlying the channel region 1006 can be relatively thin, in a range of 20 A to 500 A. Minimizing gate insulator layer thickness permits reductions in geometry for devices, such as TFT 1002.

Returning to FIG. 10, the carrier mobility and the Vₜₕ of the channel region 1006 are related to the widths 1010 and 1012. The width 808 in FIG. 8 and the width 1012 are equal. That is, channel region 806 in FIG. 8 and channel region 1012 are both bounded by consecutive first plurality (reference designator 604 in FIG. 6) grain boundaries. Therefore, the discussion for FIG. 9 regarding the width 808 carrier mobility and Vₜₕ applies to carrier mobility and Vₜₕ in the portion of channel region 1006 defined by width 1012. Regarding the width 1010, a similar methodology can be applied by using the width 1010 as the applicable sub-boundary spacing value in FIG. 7. For example, for a width 1010 in a range of 0.6 μm to 10 μm, referring to FIG. 7: for an n-type TFT 1002, carrier mobility is greater than 700 cm²/Vs and Vₜₕ is less than and equal to +/−0.1V in a range of 0V to 0.8V.

### Functional Description

The present invention polycrystalline silicon (poly-Si) film with quasi-single crystal silicon in a selected region and a method for producing grain boundary-free poly-Si in a selected region uses a combination of two Laser-Induced Lateral Growth (LILaC) processes. Each LILaC process uses different beam-shaping mask designs and scanning schemes for the substrate (which moves under the mask). The 2N-shot crystallization method is used for the first crystallization. The 2N-shot method is described in the Background Section.

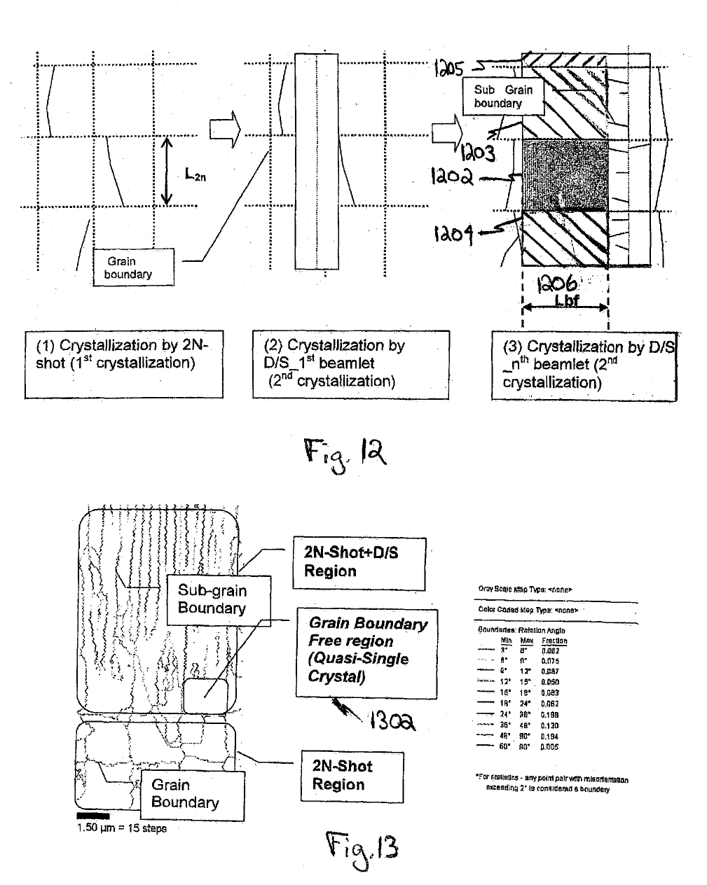

FIG. 12 illustrates the use of a directional solidification (DS) process following a 2N-shot process. The 2N-shot method provides high throughput, however, as described in the Background Section, the resulting poly-Si film still has some grain boundaries in the channel and surface roughness. Therefore, DS is used for the second crystallization. The DS process removes sub-boundaries in poly-Si located between the grain boundaries formed by the 2N-shot process and also removes 2N-shot grain boundaries perpendicular to the direction of the DS process. In addition, the DS process smoothes ridges formed by the 2N-shot grain boundaries. FIG. 12 includes crystals 1202, 1203, 1204, and 1205. Crystals 1202, 1203, 1204, and 1205 are adjoined, similar to crystals 613 and 614 described in FIG. 6. Each of crystals 1202 and 1203 have both sides, forming the length, co-located with grain boundaries parallel to the direction of the DS process, similar to the crystals 612 and 614 shown in FIG. 6. Crystals 1204 and 1205 each have only one side, forming the length, co-located with a grain boundary parallel to the direction of the DS process, similar to the crystal 613 shown in FIG. 6.

The DS process can be performed on selected areas of the 2N-shot poly-Si film. Thus, the 2N-shot process, which has a high throughput, is used to form a precursor film and the DS process, which has a lower throughput, is used, in selected areas, to prolong crystal growth and create higher-quality, smooth-surfaced, silicon. In a TFT application, the DS process can be used for channel regions where smoothness and enhanced performance, for example, carrier mobility, are at a premium, while the 2N-shot precursor film may be of sufficient quality for the remaining components. Therefore, a highly advantageous combination of high throughput and high quality can be achieved. The length (Lbf) 1206 is dependent on Si thickness and the energy density used in the DS process. Thicker film and higher energy densities permit a longer length 1206. For example, in a conventional DS process, that is without adding additional energy sources, Lbf 1206 for 500 A film typically equals 1.5 μm to 3 μm for an energy density in a range of 350 to 600 joules per square centimeter and Lbf 1206 equals approximately 4 to 5 μm for 1000 A film.

FIG. 13 shows angular distributions of the present invention silicon film and a quasi-single crystal. The rotational angle of grain boundaries for the present invention silicon film has been measured from electron backscatter diffraction (EBS) patterns. The grain boundary angle is defined as the angle of rotation required for a grain to rotate to match the crystallographic orientation of its neighbor. Typically a grain boundary signifies a rotation angle of >2°. A boundary is considered low-angle if the rotation is less than 15°. Otherwise the grain boundary is assumed to be high-angle. The quasi-single crystal 1302 is equivalent to the crystal 612 in FIG. 6.

Increasing the spacing between the 2N-shot grain boundaries can be advantageous. For example, increasing the spacing permits an increase in the width of quasi-single crystals, since the width of these crystals is limited to the distance between 2N-shot grain boundaries parallel to the length of the crystal. To increase the spacing between the 2N-shot grain boundaries, additional energy sources can be employed. For example, an additional laser can be used to irradiate the work surface, or a lamp can be used to heat the work surface. Additional energy sources also can be used in the DS process. Extra DS heat sources, for example, a laser or lamp as described above also can be used to improve the quality of the material produced by the DS process by reducing the quenching rate of the material. Reducing the quenching rate reduces the number of defects in the material and increases sub-boundary spacing in the material.

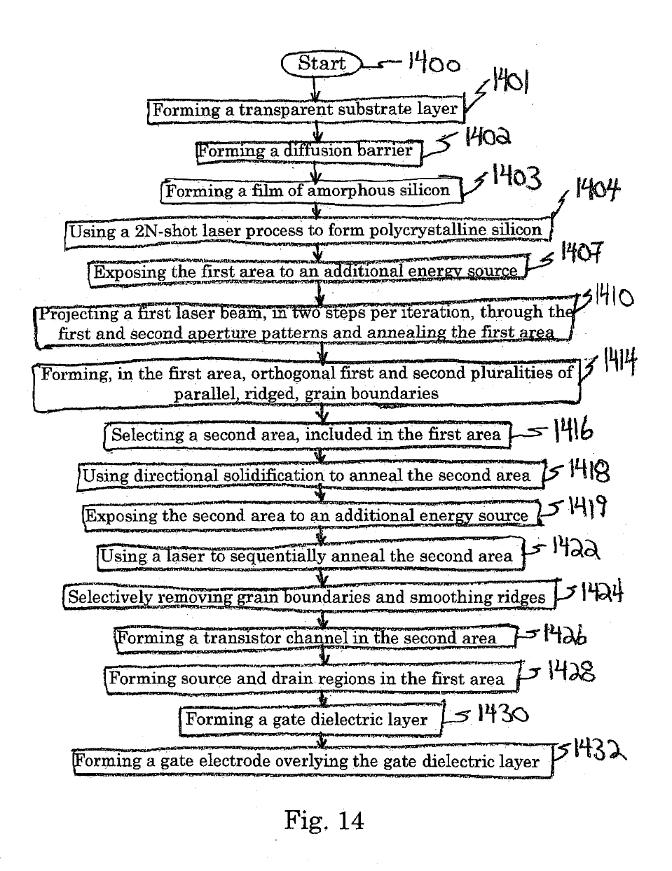

FIG. 14 is a flowchart illustrating the present invention method for producing grain boundary-free polycrystalline silicon. Although the method in FIG. 14 is depicted as a sequence of numbered steps for clarity, no order should be inferred from the numbering unless explicitly stated. It should be understood that some of these steps may be skipped, performed in parallel, or performed without the requirement of maintaining a strict order of sequence. The method starts at Step 1400. Step 1403 forms a film of amorphous silicon. Step 1404 uses a 2N-shot laser irradiation process to form polycrystalline silicon in a first area of the film. Step 1410 selects first and second aperture patterns; projects a first laser beam, in two steps per iteration, through the first and second aperture patterns; and anneals the first area. Step 1414 forms, in the first area, first and second pluralities of parallel, ridged, grain boundaries. Step 1416 selects a second area, included in the first area. Step 1418 uses a directional solidification (DS) process to anneal the second area. Step 1422, for the DS process, projects a second laser through a third aperture pattern to sequentially anneal the second area. Step 1424 selectively removes grain boundaries and smoothes grain boundary ridges in the second area.

In some aspects, using a 2N-shot laser irradiation process in Step 1404 includes sequencing irradiation in odd and even iteration patterns. In some aspects, sequencing irradiation in odd and even iteration patterns includes performing one odd iteration and one even iteration.

In some aspects, projecting a first laser beam through first and second aperture patterns in Step 1410 includes projecting a first laser beam with a wavelength less than 550 nm. In some aspects, projecting a first laser beam through first and second aperture patterns in Step 1410 includes projecting a first laser beam with a wavelength between 248 nm and 308 nm. In some aspects, projecting a first laser beam through first and second aperture patterns in Step 1410 includes using a first excimer laser source to supply the first laser beam. In some aspects, projecting a first laser beam through first and second aperture patterns in Step 1410 includes projecting the first laser beam for a pulse duration of up to 300 nanoseconds (ns). In some aspects, projecting the first laser beam for a pulse duration of up to 300 ns includes projecting the first laser beam for a pulse duration of up to 30 ns. In some aspects, projecting a first laser beam through first and second aperture patterns in Step 1410 includes projecting the first laser beam by a factor of one.

In some aspects, projecting a first laser beam and annealing the first area in Step 1410 includes projecting onto the first area top surface orthogonal first and second pluralities of rectangular first laser beamlets. In some aspects, projecting first laser beamlets includes projecting beamlets with equal widths.

In some aspects, a Step 1407 exposes the first area to an additional energy source. Then, annealing the first area in Step 1410 includes summing energy densities from the first laser and the additional energy source to anneal the first area. In some aspects, exposing the first area to an additional energy source in Step 1407 includes projecting a third laser beam. In some aspects, projecting a third laser beam includes projecting, from a solid state laser source, a third laser beam with a wavelength of 532 nm and a pulse duration of between 50 and 150 ns. In some aspects, projecting a third laser beam includes projecting, from a carbon dioxide (CO₂) laser source, a third laser beam with a wavelength in a range of 10.2 μm to 10.8 μm and a pulse duration of up to 4 milliseconds (ms).

In some aspects, exposing the first area to an additional energy source in Step 1407 includes exposing the first area to a first lamp light. In some aspects, exposing the first area to a first lamp light includes exposing the first area to a lamp light with a wavelength less than 550 nm. In some aspects, exposing the first area to a first lamp light includes using a first excimer lamp to supply the light. In some aspects, exposing the first area to a first lamp light includes exposing a first bottom surface of the amorphous silicon film including the first area. In some aspects, exposing the first area to a first lamp light includes exposing a first top surface of the amorphous silicon film including the first area.

In some aspects, forming, in the first area, first and second pluralities of parallel, ridged, grain boundaries in Step 1414 includes equally separating first plurality consecutive grain boundaries by a first width and equally separating second plurality consecutive grain boundaries by a second width. In some aspects, equally separating first and second consecutive grain boundaries by first and second widths, respectively, includes selecting widths in a range of 0.1 microns (μm) to 100 μm. In some aspects, selecting widths in a range of 0.1 μm to 100 μm includes selecting the first and second widths in a range of 0.1 μm to 0.6 μm. In some aspects, selecting widths in a range of greater than 0.1 μm to 0.6 μm includes selecting the first and second widths in a range of 0.3 μm to 0.6 μm. In some aspects, selecting widths in a range of 0.1 μm to 100 μm includes selecting the first and second widths in a range of 0.6 μm to 10 μm. In some aspects, selecting widths in a range of 0.1 μm to 100 μm includes selecting the first and second widths in a range of 10 μm to 100 μm.

In some aspects, selecting the second area in Step 1416 includes selecting a first pair of sides located between first plurality grain boundaries and selecting a second pair of sides located between second plurality grain boundaries. In some aspects, locating the first pair of sides includes co-locating one or both of the sides on a first plurality grain boundary. In some aspects, locating the first pair of sides includes locating the pair between consecutive first plurality grain boundaries. In some aspects, locating the pair between consecutive first plurality grain boundaries includes co-locating one or both of the sides on the consecutive first plurality grain boundaries. In some aspects, locating the second pair of sides includes co-locating one or both of the sides on a second plurality grain boundary. In some aspects, locating the second pair of sides includes locating the pair between consecutive second plurality grain boundaries. In some aspects, locating the pair between consecutive second plurality grain boundaries includes co-locating one or both of the sides on the consecutive second plurality grain boundaries.

In some aspects, projecting a second laser through a third aperture pattern in Step 1422 includes projecting a second laser beam with a wavelength less than 550 nm. In some aspects, projecting a second laser through a third aperture pattern in Step 1422 includes projecting a second laser beam with a wavelength between 248 nm and 308 nm. In some aspects, projecting a second laser through a third aperture pattern in Step 1422 includes using a second excimer laser source to supply the second laser beam. In some aspects, projecting a second laser through a third aperture pattern in Step 1422 includes projecting the second laser beam for a pulse duration of up to 300 ns. In some aspects, projecting the second laser beam for a pulse duration of up to 300 ns includes projecting the second laser beam for a pulse duration of up to 30 ns. In some aspects, projecting a second laser through a third aperture pattern in Step 1422 includes projecting the second laser beam by a factor of one.

In some aspects, projecting a second laser through a third aperture pattern to sequentially anneal the second area in Step 1422 includes selecting a direction for the sequencing equal to a direction of a last iteration in a 2N-shot iteration pattern.

In some aspects, a Step 1419 exposes the second area to an additional energy source. Then, annealing the second area in Step 1422 includes summing energy densities from the second laser and the additional energy source to anneal the second area. In some aspects, exposing the second area to an additional energy source in Step 1419 includes projecting a fourth laser beam. In some aspects, projecting a fourth laser beam includes projecting, from a solid state laser source, a fourth laser beam with a wavelength of 532 nm and a pulse duration of between 50 and 150 ns. In some aspects, projecting a fourth laser beam includes projecting, from a CO₂ laser source, a fourth laser beam with a wavelength in a range of 10.2 μm to 10.8 μm and a pulse duration of up to 4 ms.

In some aspects, exposing the second area to an additional energy source in Step 1419 includes exposing the second area to a second lamp light. In some aspects, exposing the second area to a second lamp light includes exposing the second area to a lamp light with a wavelength less than 550 nm. In some aspects, exposing the second area to a second lamp light includes using a second excimer lamp to supply the light. In some aspects, exposing the second area to a second lamp light includes exposing a second bottom surface of the amorphous silicon film including the second area. In some aspects, exposing the second area to a second lamp light includes exposing a second top surface of the amorphous silicon film including the second area.

In some aspects, selectively removing grain boundaries in the second area in Step 1424 includes removing grain boundaries with the exception of grain boundaries included in the first plurality of grain boundaries.

The following describes one possible sequence for forming a TFT using the present invention method. It is understood that other sequences also are possible for FIG. 14. In some aspects of the method, Step 1401 form is a transparent substrate layer. Then, Step 1402 forms a diffusion barrier overlying the substrate layer and underlying the first area. In some aspects, Step 1426, following the smoothing of grain boundary ridges in the second area in Step 1424, forms a transistor channel with a length and a width in the second area. Then: Step 1428 forms source and drain regions in the first area; Step 1430 forms a gate dielectric layer overlying the transistor channel, source, and drain regions, the dielectric layer having a thickness in a range of 20 A to 500 A over the channel; and Step 1432 forms a gate electrode overlying the gate dielectric layer.

In some aspects, forming a transistor channel in the second area in Step 1426 includes forming the channel length with a first pair of sides located between a pair of first plurality grain boundaries and forming a channel region with a width includes forming the channel width with a second pair of sides located between a pair of second plurality grain boundaries. Then, selectively removing grain boundaries in the second area in Step 1424 includes removing, from the channel, grain boundaries with the exception of grain boundaries in the first plurality and located between the pair of first plurality grain boundaries.

In some aspects, forming the channel length with a first pair of sides includes co-locating one or both of the sides on a first plurality grain boundary. In some aspects, forming the channel length with a first pair of sides includes locating the sides between a pair of consecutive first plurality grain boundaries. In some aspects, locating the sides between a pair of consecutive first plurality grain boundaries includes co-locating one or both of the sides on the consecutive first plurality grain boundaries. In some aspects, forming the channel width with a second pair of sides includes co-locating one or both of the sides on the second plurality grain boundaries. In some aspects, forming the channel length with a second pair of sides includes locating the sides between a pair of consecutive second plurality grain boundaries. In some aspects, locating the sides between a pair of consecutive second plurality grain boundaries includes co-locating one or both of the sides on the consecutive second plurality grain boundaries.

In some aspects, selecting widths in a range of 0.1 μm to 0.6 μm includes selecting the first and second widths in a range of 0.3 μm to 0.6 μm. Then, forming a transistor channel in the second area in Step 1426 includes: for n-type TFTs, forming the channel with a mobility of greater than 500 square centimeters per volt-second (cm²/Vs) and a threshold voltage (Vₜₕ) of less than and equal to +/−0.35V in a range of OV to 1V and for p-type TFTs, forming the channel with a mobility of greater than 200 cm²/Vs and a Vₜₕ of less than and equal to −/−0.35V in a range of −1V to 0V.

In some aspects, selecting widths in a range of 0.1 μm to 100 μm includes selecting the first and second widths in a range of 0.6 μm to 10 μm. Then, forming a transistor channel in the second area in Step 1426 includes: for n-type TFTs, forming the channel with a mobility of greater than 700 cm²/Vs and a Vₜₕ of less than and equal to +/−0.1V in a range of 0V to 0.8V; and for p-type TFTs, forming the channel with a mobility of greater than 250 cm²/Vs and a Vₜₕ of less than and equal to +/−0.1V in a range of −0.8V to 0V.

In some aspects, selecting widths in a range of 0.1 μm to 100 μm includes selecting the first and second widths in a range of 10 μm to 100 μm. Then, forming a transistor channel in the second area in Step 1426 includes: for n-type TFTs, forming the channel with a mobility of approximately 750 cm²/Vs and a Vₜₕ of less than and equal to +/−0.01V in a range of 0V to 0.1V; and for p-type TFTs, forming the channel with a mobility of greater than 250 cm²/Vs and a Vₜₕ of less than and equal to +/−0.01V in a range of −0.1V to 0V.

A polycrystalline silicon film with quasi-single crystal silicon in a selected region has been provided. A method for producing grain boundary-free polycrystalline silicon in a selected region also has been provided.

Examples have been provided using a 2N-shot laser annealing process followed by a DS process. However, the present invention is not limited to the use of a 2N-shot process prior to the DS process. For example, a continuous grain silicon (CGS) process or a conventional excimer laser anneal (ELA) process could precede the DS process. Examples have been provided of some material configurations, such as a TFT. Likewise, some process specifics have been given to clearly explain the fundamental concepts. However, the present invention is not limited to just those thickness, configurations, and specifics. Other variations and embodiments of the present invention will occur to those skilled in the art.

Although the invention has been described with reference to particular embodiments, the description is only an example of the invention's application and should not be taken as a limitation. Consequently, various adaptations and combinations of features of the embodiments disclosed are within the scope of the invention as encompassed by the following claims.

We claim:

1. A method for producing grain boundary-free polycrystalline silicon, the method comprising:
forming a film of amorphous silicon;
using a 2N-shot laser irradiation process to form polycrystalline silicon in a first area of the film;
selecting a second area, included in the first area; and,
using a directional solidification (DS) process to anneal the second area.

2. The method of claim 1 wherein using a 2N-shot laser irradiation process to form polycrystalline silicon in a first area of the film includes sequencing irradiation in odd and even iteration patterns, the patterns including:
for odd numbered iterations, projecting a first laser beam, in two steps, through a first aperture pattern oriented in a first direction; and,
for even numbered iterations, projecting the first laser beam, in two steps, through a second aperture pattern oriented in a second direction orthogonal to the first direction.

3. The method of claim 2 wherein using a 2N-shot laser irradiation process to form polycrystalline silicon in a first area of the film includes forming in the first area:
a first plurality of parallel grain boundaries oriented in the first direction and having consecutive grain boundaries equally spaced by a first width; and,
a second plurality of parallel grain boundaries oriented in the second direction and having consecutive grain boundaries equally spaced by a second width.

4. The method of claim 3 wherein forming first and second pluralities of grain boundaries having respective consecutive grain boundaries equally spaced by first and second widths, respectively, includes:
selecting the first width in a range of 0.1 microns (μm) to 100 μm; and,
selecting the second width in a range of 0.1 μm to 100 μm.

5. The method of claim 4 wherein selecting the first and second widths in respective ranges of 0.1 μm to 100 μm includes:
selecting the first width in a range of 0.1 μm to 0.6 μm; and,
selecting the second width in a range of 0.1 μm to 0.6 μm.

6. The method of claim 5 wherein selecting the first and second widths in respective ranges of 0.1 μm to 0.6 μm includes:
selecting the first width in a range of 0.3 μm to 0.6 μm; and,
selecting the second width in a range of 0.3 μm to 0.6 μm.

7. The method of claim 4 wherein selecting the first and second widths in respective ranges of 0.1 μm to 100 μm includes:
selecting the first width in a range of 0.6 μm to 10 μm; and,
selecting the second width in a range of 0.6 μm to 10 μm.

8. The method of claim 4 wherein selecting the first and second widths in respective ranges of 0.1 μm to 100 μm includes:
selecting the first width in a range of 10 μm to 100 μm; and,
selecting the second width in a range of 10 μm to 100 μm.

9. The method of claim 3 wherein forming first and second pluralities of grain boundaries with first and second widths, respectively, includes selecting the first and second widths to be equal.

10. The method of claim 3 wherein sequencing irradiation in odd and even iteration patterns includes performing one odd iteration and one even iteration.

11. The method of claim 3 wherein using a DS process to anneal the second area includes:
selecting a third aperture pattern;
orienting the third aperture pattern and a second area top surface in the first direction;
projecting a second laser beam through the third aperture pattern to anneal a first portion of the second area;
sequentially:
advancing the third aperture pattern and the second area top surface in the first direction;
projecting the second laser beam through the third aperture pattern; and,
annealing remaining portions of the second area; and,
selectively removing grain boundaries in the second area.

12. The method of claim 11 wherein selectively removing grain boundaries in the second area includes:
smoothing ridges formed by the first and second pluralities of grain boundaries; and,
removing grain boundaries with the exception of first plurality grain boundaries.

13. The method of claim 12 wherein selecting the second area includes:
selecting a first pair of sides parallel to and located between first plurality grain boundaries; and,
selecting a second pair of sides parallel to and located between second plurality grain boundaries.

14. The method of claim 13 wherein selecting a first pair of sides located between first plurality grain boundaries includes selecting at least one first pair side to be co-located on a first plurality grain boundary.

15. The method of claim 13 wherein selecting a first pair of sides located between first plurality grain boundaries includes selecting a first pair of sides located between consecutive first plurality grain boundaries.

16. The method of claim 15 wherein selecting a first pair of sides located between consecutive first plurality grain boundaries includes selecting at least one first pair side to be co-located on a consecutive first plurality grain boundary.

17. The method of claim 13 wherein selecting a second pair of sides located between second plurality grain boundaries includes selecting at least one second pair side to be co-located on a second plurality grain boundary.

18. The method of claim 11 wherein orienting the third aperture pattern and a second area top surface in the first direction includes selecting the first direction the same as a direction of a last iteration in a 2N-shot iteration sequence performed on the first area.

19. The method of claim 3 wherein projecting a first laser beam through first and second aperture patterns includes using a first excimer laser source with a wavelength between 248 nanometers (nm) and 308 nm to supply the first laser beam; and,
wherein projecting a second laser beam through a third aperture pattern includes using a second excimer laser source with a wavelength between 248 nm and 308 nm to supply the second laser beam.

20. The method of claim 3 wherein projecting a first laser beam through first and second aperture patterns includes projecting the first laser beam for a pulse duration of up to 300 nanoseconds (ns); and,
wherein projecting a second laser beam through a third aperture pattern includes projecting the second laser beam for a pulse duration of up to 300 ns.

21. The method of claim 20 wherein projecting a first laser beam through first and second aperture patterns includes projecting the first laser beam for a pulse duration of up to 30 ns.

22. The method of claim 3 wherein projecting a first laser beam through first and second aperture patterns includes projecting the first laser beam by a factor of one.

23. The method of claim 20 wherein projecting the second laser beam through the third aperture pattern includes projecting the second laser beam for a pulse duration of up to 30 ns.

24. The method of claim 11 wherein projecting a second laser beam through the third aperture pattern includes projecting the second laser beam by a factor of one.

25. The method of claim 3 wherein projecting a first laser beam to anneal the first area includes exposing the first area to a first energy density from the first laser beam;
the method further comprising:
projecting a third laser beam onto the first area; and,
exposing the first area to a second energy density from the third laser beam; and,
wherein annealing the first area includes:
summing the first and second energy densities to yield a third energy density; and,
annealing the first area in response to the third energy density.

26. The method of claim 25 wherein proj ecting a third laser beam onto the first area includes projecting, from a solid state laser source, a third laser beam with a wavelength of 532 nm and a pulse duration of between 50 ns and 150 ns.

27. The method of claim 25, wherein projecting a third laser beam onto the first area includes projecting, from a carbon dioxide (CO₂) laser source, a third laser beam with a wavelength in a range of 10.2 μm to 10.8 μm and a pulse duration of up to 4 milliseconds (ms).

28. The method of claim 3 wherein projecting a first laser beam to anneal the first area includes exposing the first area to a fourth energy density from the first laser beam;
the method further comprising:
exposing the first area to a first lamp light; and
exposing the first area to a fifth energy density from the first lamp light; and,
wherein annealing the first area includes:
summing the fourth and fifth energy densities to yield a sixth energy density; and,
annealing the first area in response to the sixth energy density.

29. The method of claim 28 wherein exposing the first area to a first lamp light includes exposing the first area to light from an excimer lamp with a wavelength less than 550 nm.

30. The method of claim 28 wherein exposing the first area to a first lamp light includes exposing a first bottom surface of the amorphous silicon film including the first area.

31. The method of claim 28 wherein exposing the first area to a first lamp light includes exposing a first top surface of the amorphous silicon film including the first area.

32. The method of claim 11 wherein projecting a second laser beam to anneal the second area includes exposing the second area to a seventh energy density from the second laser beam;
the method further comprising:
projecting a fourth laser beam onto the second area; and,
exposing the second area to an eighth energy density from the fourth laser beam; and,
wherein annealing the second area includes:
summing the seventh and eighth energy densities to yield a ninth energy density; and,
annealing the second area in response to the ninth energy density.

33. The method of claim 32 wherein projecting a fourth laser beam onto the second area includes projecting, from a solid state laser source, a fourth laser beam with a wavelength of 532 nm and a pulse duration of between 50 ns and 150 ns.

34. The method of claim 32 wherein projecting a fourth laser beam onto the second area includes projecting, from a CO₂ laser source, a third laser beam with a wavelength in a range of 10.2 μm to 10.8 μm and a pulse duration of up to 4 ms.

35. The method of claim 11 wherein projecting a second laser beam to anneal the second area includes exposing the second area to a tenth energy density from the second laser beam;
the method further comprising:
exposing the second area to a second lamp light; and
exposing the second area to an eleventh energy density from the second lamp light; and,
wherein annealing the second area includes:
summing the tenth and eleventh energy densities to yield a twelfth energy density; and,
annealing the second area in response to the twelfth energy density.

36. The method of claim 35 wherein exposing the second area to a second lamp light includes exposing the second area to light from an excimer lamp with a wavelength less than 550 nm.

37. The method of claim 35 wherein exposing the second area to a second lamp light includes exposing a second bottom surface of the amorphous silicon film including the second area.

38. The method of claim 35 wherein exposing the second area to a second lamp light includes exposing a second top surface of the amorphous silicon film including the second area.

39. The method of claim 11 further comprising:
forming a transparent substrate layer;
forming a diffusion barrier overlying the substrate layer and underlying the first area;
forming in the second area, a transistor channel with a length, oriented in the first direction, and a width;
forming in the first area, source and drain regions adjacent to the channel region;
forming a gate dielectric layer overlying the transistor channel, source, and drain regions, the dielectric thickness in a range of 20 angstroms (A) to 500 A over the channel region; and,
forming a gate electrode overlying the gate dielectric layer.

40. The method of claim 39 wherein forming a channel region with a length includes forming the channel length with a first pair of sides parallel to and located between a pair of first plurality grain boundaries; and,
wherein forming a channel region with a width includes forming the channel width with a second pair of sides parallel to and located between a pair of second plurality grain boundaries.

41. The method of claim 40 wherein forming the channel length with a first pair of parallel sides located between a pair of first plurality grain boundaries includes co-locating at least one side from the first pair on a first plurality grain boundary.

42. The method of claim 40 wherein forming the channel length with a first pair of parallel sides located between a pair of first plurality grain boundaries includes forming the channel length with a first pair of parallel sides located between a pair of consecutive first plurality grain boundaries.

43. The method of claim 42 wherein forming the channel length with a first pair of parallel sides located between a pair of consecutive first plurality grain boundaries includes co-locating at least one side from the first pair on a first plurality grain boundary.

44. The method of claim 40 wherein forming the channel width with a second pair of parallel sides located between a pair of second plurality grain boundaries includes co-locating at least one side from the second pair on a second plurality grain boundary.

45. The method of claim 40 wherein forming first and second pluralities of grain boundaries having respective consecutive grain boundaries equally spaced by first and second widths, respectively, includes:
selecting the first width in a range of 0.1 μm to 100 μm; and,
selecting the second width in a range of 0.1 μm to 100 μm.

46. The method of claim 45 wherein selecting the first width in a range of 0.1 μm to 100 μm includes selecting the first width in a range of 0.3 μm to 0.6 μm; and,
wherein forming a transistor channel includes:
for n-type TFTs, forming the channel with a carrier mobility of greater than 500 square centimeters per volt-second (cm²/Vs) and a threshold voltage (Vₜₕ) of less than and equal to +/−0.35V in a range of 0V to 1V; and,
for p-type TFTs, forming the channel with an carrier mobility of greater than 200 cm²/Vs and a Vₜₕ of less than and equal to +/−0.35V in a range of −1V to 0V.

47. The method of claim 45 wherein selecting the first width in a range of 0.1 μm to 100 μm includes selecting the first width in a range of 0.6 μm to 10 μm; and,
wherein forming a transistor channel includes:
for n-type TFTs, forming the channel with an carrier mobility of greater than 700 cm²/Vs and a Vₜₕ of less than and equal to +/−0.1V in a range of 0V to 0.8V; and,
for p-type TFTs, forming the channel with an carrier mobility of greater than 250 cm²/Vs and a Vₜₕ of less than and equal to +/−0.1V in a range of −0.8V to 0V.

48. The method of claim 45 wherein selecting the first width in a range of 0.1 μm to 100 μm includes selecting the first width in a range of 10 μm to 100 μm; and,
wherein forming a transistor channel includes:
for n-type TFTs, forming the channel with an carrier mobility of approximately 750 cm²/Vs and a Vₜₕ of less than and equal to +/−0.01V in a range of 0V to 0.1V; and,
for p-type TFTs, forming the channel with an carrier mobility of greater than 250 cm²/Vs and a Vₜₕ of less than and equal to +/−0.01V in a range of −0.1V to 0V.

49. A polycrystalline silicon film with a quasi-single crystal region, the film comprising:
a polycrystalline grid region having a first plurality of parallel grain boundaries orthogonal to a second plurality of parallel grain boundaries; and,
in the grid region, a third plurality of quasi-single crystals, each crystal having:
a first pair of sides forming a length, the first pair of sides parallel to and located between a pair of consecutive first plurality grain boundaries; and,
a second pair of sides forming a width, the second pair of sides parallel to and located between a pair of second plurality grain boundaries.

50. The film of claim 49 wherein at least one side in the first pair of sides is co-located on a first plurality grain boundary.

51. The film of claim 49 wherein at least one side in the second pair of sides is co-located on a second plurality grain boundary.

52. The film of claim 49 wherein the third plurality of quasi-single crystals includes crystals with shared grain boundaries.

53. The film of claim 49 wherein grid region first plurality consecutive grain boundaries are equally separated by a first distance in a range of 0.1 microns (μm) to 100 μm; and,
wherein grid region second plurality consecutive grain boundaries are equally separated by a second distance in a range of 0.1 μm to 100 μm.

54. The film of claim 53 wherein grid region first plurality consecutive grain boundaries are equally separated by a first distance in a range of 0.3 μm to 0.6 μm;
wherein for n-type film, the carrier mobility is greater than 500 square centimeters per volt-second (cm²/Vs); and,
wherein for p-type film, the carrier mobility is greater than 200 cm²/Vs.

55. The film of claim 53 wherein grid region first plurality consecutive grain boundaries are equally separated by a first distance in a range of 0.6 μm to 10 μm;
wherein for n-type film, the carrier mobility is greater than 700 cm²/Vs; and,
wherein for p-type film, the carrier mobility is greater than 250 cm²/Vs.

56. The film of claim 53 wherein grid region first plurality consecutive grain boundaries are equally separated by a first distance in a range of 10 μm to 100 μm;
wherein for n-type film, the carrier mobility is approximately 750 cm²/Vs; and,
wherein for p-type film, the carrier mobility is greater than 250 cm²/Vs.

57. A thin film transistor (TFT) with a channel region formed from quasi-single crystal silicon, the TFT comprising:
a transparent substrate;
a diffusion barrier overlying the transparent substrate;
a polycrystalline silicon grid region, overlying the diffusion barrier, the grid region including:
a first plurality of parallel grain boundaries orthogonal to a second plurality of parallel grain boundaries;
a channel region formed from a plurality of quasi-single crystals having shared grain boundaries, each crystal having:
a first pair of sides forming a length, the first pair of sides parallel to and located between a pair of consecutive first plurality grain boundaries; and,
a second pair of sides forming a width, the second pair of sides parallel to and located between a pair of second plurality grain boundaries;
source and drain regions adjacent the channel region;
an oxide gate insulator layer overlying the silicon layer, the insulator layer having a thickness in a range of 20 angstroms (A) to 500 A over the channel region; and,
a gate electrode overlying the oxide gate insulator layer.

58. The TFT of claim 57 wherein at least one side in the first pair of sides is co-located on a first plurality grain boundary.

59. The TFT of claim 57 wherein at least one side in the second pair of sides is co-located on a second plurality grain boundary.

60. The TFT of claim 57 wherein the channel region is formed from a single quasi-single crystal.

61. The TFT of claim 57 wherein grid region first plurality consecutive grain boundaries are equally separated by a first distance in a range of greater than 0.1 microns (μm) to 100 μm; and,
wherein grid region second plurality consecutive grain boundaries are equally separated by a second distance in a range of greater than 0.1 μm to 100 μm.

62. The TFT of claim 61 wherein grid region first plurality consecutive grain boundaries are equally separated by a first distance in a range of 0.3 μm to 0.6 μm; and,
wherein the channel region has:
for n-type TFTs, an carrier mobility of greater than 500 square centimeters per volt-second (cm²/Vs) and a threshold voltage (Vₜₕ) of less than and equal to +/−0.35V in a range of 0V to 1V; and,
for p-type TFTs, an carrier mobility of greater than 200 cm²/Vs and a Vₜₕ of less than and equal to +/−0.35V in a range of −1V to 0V.

63. The TFT of claim 61 wherein grid region first plurality consecutive grain boundaries are equally separated by a first distance in a range of 0.6 μm to 10 μm; and,
wherein the channel region has:
for n-type TFTs, an carrier mobility of greater than 700 cm²/Vs and a Vₜₕ of less than and equal to +/−0.1V in a range of 0V to 0.8V; and,
for p-type TFTs, an carrier mobility of greater than 250 cm²/Vs and a Vₜₕ of less than and equal to +/−0.1V in a range of −0.8V to 0V.

64. The TFT of claim 61 wherein grid region first plurality grain boundaries are equally separated by a first distance in a range of 10 μm to 100 μm; and,
wherein the channel region has:
for n-type TFTs, an carrier mobility of approximately 750 cm²/Vs and a Vₜₕ of less than and equal to +/−0.01V in a range of 0V to 0.1V; and,
for p-type TFTs, an carrier mobility of greater than 250 cm²/Vs and a Vₜₕ of less than and equal to +/−0.01V in a range of −0.1V to 0V.
